(19) United States
(12) Patent Application Publication
(10) Pub. No.: US 2019/0228770 A1
(43) Pub. Date: Jul. 25, 2019

(54) VOICE CONTROL METHOD, DEVICE, AND COMPUTER STORAGE MEDIUM

(71) Applicant: ZTE CORPORATION, Shenzhen (CN)

(72) Inventor: Tengfei LI, Shenzhen (CN)

(21) Appl. No.: 16/319,950

(22) PCT Filed: Nov. 11, 2016
(86) PCT No.: PCT/CN2016/105489

§ 371 Date: Jan. 23, 2019

(30) Foreign Application Priority Data
Aug. 24, 2016 (CN) 201610718871.6

(51) Int. Cl. G10L 15/22; H04M 1/725; G06F 3/16

(52) U.S. Cl. CPC G10L 15/22; G10L 2015/223; G06F 3/167; H04M 1/72519

(57) ABSTRACT

A voice control method, device, and computer storage medium. The method comprises: in a call process, determining whether first voice information occurs (S202); upon acquiring the first voice information, acquiring second voice information (S204); and controlling, according to the second voice information, the call process (S206).

### TECHNICAL FIELD

The disclosure relates to the field of communications, and in particular to a voice control method and device, and a computer storage medium.

### BACKGROUND

With the popularity of electronic devices with communication functions, wireless communication has become a normal behavior in life. However, the quality of wireless communication will be affected by various factors, such as device, network and environment, which may cause a volume of a voice signal of wireless communication to be high or low. Therefore, a user needs to perform an operation of volume adjustment, and may also need to perform other processing operations during the call, thereby making the experience of the communication behavior worse.

In the related art, other processing functions can be performed simultaneously during the call process, but a manual operation is required, which is not intelligent enough, and the required operations are not convenient in the communication process. The voice control solution in the related art cannot achieve control during the call process.

In view of the above problems in the related art, no effective solution has been found yet.

### SUMMARY

The embodiments of the disclosure provide a method and a device for voice control, and a computer storage medium, to solve at least the technical problem in the related art that voice control cannot be performed during a call process.

According to an embodiment of the disclosure, a method for voice control is provided. The method includes the following operations. It is detected, during a call process, whether first voice information occurs. Second voice information is collected after the first voice information is acquired. The call process is controlled according to the second voice information.

As an implementation, before it is detected whether first voice information occurs, the method may further include the following operations. Voiceprint information of a call user is collected. It is determined whether the voiceprint information of the call user matches prestored voiceprint information.

As an implementation, according to the second voice information, at least one of the following controls may be performed on the call process: adjusting a received volume, starting recording, ending recording, adjusting a transmission level, ending a present call, or performing a custom action.

As an implementation, the method may further include the following operations. After the second voice information is collected, it is determined whether third voice information is received within a preset time. When it is determined that the third voice information is received within the preset time, the collection of the second voice information is stopped.

As an implementation, when it is determined that the third voice information is not received within the preset time, the method may include the following operation. It is instructed to stop controlling the call process according to the second voice information.

According to another embodiment of the disclosure, a device for voice control is provided. The device includes a detection module, a first collection module and a control module. The detection module is configured to detect, during a call process, whether first voice information occurs. The first collection module is configured to collect second voice information after the detection module acquires the first voice information. The control module is configured to control the call process according to the second voice information collected by the first collection module.

As an implementation, the device may further include a second collection module and a determination module. The second collection module is configured to collect voiceprint information of a call user before the detection module detects whether first voice information occurs. The determination module is configured to determine whether the voiceprint information of the call user matches prestored voiceprint information.

As an implementation, the control module may be configured to perform, according to the second voice information, at least one of the following controls on the call process: adjusting a received volume, starting recording, ending recording, adjusting a transmission level, ending a present call, or performing a custom action.

As an implementation, the device may further include a judgment module and a first processing module. The judgment module is configured to determine, after the first collection module collects the second voice information, whether third voice information is received within a preset time. The first processing module is configured to control, when it is determined that the third voice information is received within the preset time, the first collection module to stop collecting the second voice information.

As an implementation, the device may include a second processing module, which is configured to instruct, when it is determined that the third voice information is not received within the preset time, the control module to stop controlling the call process according to the second voice information.

According to another embodiment of the disclosure, a computer storage medium is also provided. The computer storage medium may have a computer executable instruction stored therein, the computer executable instruction being used to perform the method for voice control according to the embodiment of the disclosure.

In the embodiments of the disclosure, it is detected, during a call process, whether first voice information occurs. Second voice information is collected after the first voice information is acquired. The call process is controlled according to the second voice information. Accordingly, the technical problem in the related art that voice control cannot be performed during a call process can be solved, thereby providing a better and more convenient communication experience.

### BRIEF DESCRIPTION OF DRAWINGS

The accompanying drawings described herein are used to provide further understanding of the disclosure, and constitute a part of the disclosure, and the exemplary embodiments of the disclosure and the description thereof are used to explain the disclosure, and do not unduly limit the disclosure. In the drawings:

FIG. 1 is a block diagram illustrating a hardware structure of a mobile terminal of a method for voice control according to an embodiment of the disclosure;

FIG. 2 is a flowchart of a method for voice control according to an embodiment of the disclosure;

FIG. 3 is a structural block diagram of a device for voice control according to an embodiment of the disclosure;

FIG. 4 is a flow diagram of a method according to an embodiment of the disclosure; and

FIG. 5 is an embodiment of a system interaction of a device according to an embodiment of the disclosure.

### DETAILED DESCRIPTION

The disclosure will be described in detail below with reference to the drawings in conjunction with the embodiments. It is to be noted that, in the case of no conflict, the features in the embodiments and the embodiments in the disclosure may be combined with each other.

It is to be noted that, the terms “first”, “second” and the like in the specification, claims of the disclosure and the above drawings are used to distinguish similar objects, and are not necessarily used to describe a specific order or a precedence.

### First Embodiment

The method embodiment in the first embodiment of the disclosure may be executed in a mobile terminal, a computer terminal or a similar computing device.

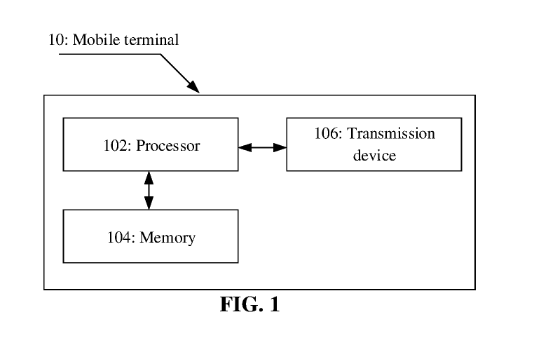

Taking running on a mobile terminal as an example, FIG. 1 is a block diagram illustrating a hardware structure of a mobile terminal of a method for voice control according to an embodiment of the disclosure. As illustrated in FIG. 1, a mobile terminal 10 may include at least one (only one illustrated in FIG. 1) processor 102 (the processor 102 may include but is not limited to a processing device such as a micro control unit (MCU) or a field programmable gate array (FPGA)), a memory 104 configured to store data, and a transmission device 106 configured to perform a communication function. It will be understood by those skilled in the art that the structure illustrated in FIG. 1 is merely illustrative and does not limit the structure of the above electronic device. For example, the mobile terminal 10 may also include more or fewer components than those illustrated in FIG. 1, or have a different configuration than that illustrated in FIG. 1.

The memory 104 may be configured to store a software program and a module of application software, such as a program instruction/module corresponding to a method for voice control in the embodiments of the disclosure. The processor 102 executes various functional applications and data processing by running the software program and module stored in the memory 104. That is, implementing the above method. The memory 104 may include a high speed random access memory and may also include a non-volatile memory such as at least one magnetic storage device, a flash memory, or other non-volatile solid state memories. In some examples, the memory 104 may further include memories remotely disposed relative to the processor 102, which may be connected to the mobile terminal 10 via a network. The examples of the above networks include, but are not limited to, the Internet, the Intranet, local area networks, mobile communication networks, and combinations thereof.

The transmission device 106 is configured to receive or send data via a network. Specific examples of the above network may include a wireless network provided by a communication provider of the mobile terminal 10. In an example, the transmission device 106 includes a network interface controller (NIC) that can be connected to other network devices via a base station to communicate with the Internet. In an example, the transmission device 106 may be a radio frequency (RF) module for communicating with the Internet wirelessly.

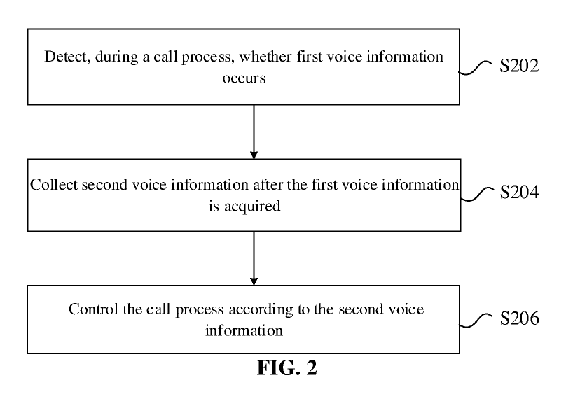

A method for voice control running on the above mobile terminal is provided in the present embodiment. FIG. 2 is a flowchart of a method for voice control according to an embodiment of the disclosure. As illustrated in FIG. 2, the flow includes the operations as follows.

At block S202, it is detected, during a call process, whether first voice information occurs.

At block S204, second voice information is collected after the first voice information is acquired.

At block S206, the call process is controlled according to the second voice information.

In the above operations, it is detected, during a call process, whether first voice information occurs. Second voice information is collected after the first voice information is acquired. The call process is controlled according to the second voice information. Accordingly, the technical problem in the related art that voice control cannot be performed during a call process can be solved, thereby providing a better and more convenient communication experience.

As an implementation, an executing body of the above operations may be a terminal that can perform human-computer interaction by voice, such as a mobile phone, but is not limited thereto.

As an implementation, before it is detected whether first voice information occurs, the method for voice control in the present embodiment may further include the operations as follows.

At S11, voiceprint information of a call user is collected.

At S12, it is determined whether the voiceprint information of the call user matches prestored voiceprint information. In this way, a main control user of voice control can be determined. In a scene with a high security level, after first voice information is acquired, it may also be determined whether voiceprint information in the first voice information matches prestored voiceprint information. In the case of matching, the subsequent operations are continued to be performed.

As an implementation, according to the second voice information, at least one of the following controls may be performed on the call process: adjusting a received volume, starting recording, ending recording, adjusting a transmission level, ending a present call, or performing other custom controls such as screen on, screen shot, and application open.

As an implementation, after the second voice information is collected, the method may further include the operations as follows.

At S21, it is determined whether third voice information is received within a preset time.

At S22, when it is determined that the third voice information is received within the preset time, the collection of the second voice information is stopped. The call process is controlled according to the previously collected second voice information. In another judging branch, when it is determined that the third voice information is not received within the preset time, the method for voice control in the present embodiment further includes the following operation. It is instructed to stop controlling the call process according to the second voice information. The first voice information may be continued to be collected.

As an implementation, the first voice information, the second voice information and the third voice information in the present embodiment may be set specific sentences. For example, the first voice information may be preset to “HELLO”, “Wait a moment, voice control”, etc.

According to the description of the above implementations, those skilled in the art can clearly understand that the method according to the above embodiment may be implemented by means of software and a necessary general hardware platform, and of course, may also be implemented by hardware. However, in many cases, the former is a better implementation. Based on such understanding, a part of the technical solution of the disclosure, which is essential or makes a contribution to the related art, may be embodied in the form of a software product. The computer software product is stored in a storage medium (such as a ROM/RAM, a magnetic disk and an optical disc), including several instructions to cause a terminal device (which may be a mobile phone, a computer, a server, or a network device, etc.) to perform the methods described in various embodiments of the disclosure.

### Second Embodiment

In the present embodiment, a device for voice control is also provided. The device is used to implement the above embodiments and preferred implementations, and those already described will not be described. As used below, the term “module” may implement a combination of software and/or hardware of a predetermined function. Although the device described in the following embodiments is preferably implemented by software, hardware or a combination of software and hardware is also possible and contemplated.

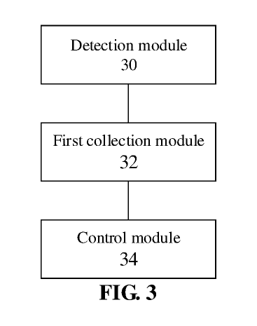

FIG. 3 is a structural block diagram of a device for voice control according to an embodiment of the disclosure. As illustrated in FIG. 3, the device includes a detection module 30, a first collection module 32 and a control module 34.

The detection module 30 is configured to detect, during a call process, whether first voice information occurs.

The first collection module 32 is configured to collect second voice information after the detection module 30 acquires the first voice information.

The control module 34 is configured to control the call process according to the second voice information collected by the first collection module 32.

As an implementation, the device for voice control in the present embodiment may further include a second collection module and a determination module. The second collection module is configured to collect voiceprint information of a call user before the detection module 30 detects whether first voice information occurs.

The determination module is configured to determine whether the voiceprint information of the call user matches prestored voiceprint information.

As an implementation, the control module 34 is configured to perform, according to the second voice information, at least one of the following controls on the call process: adjusting a received volume, starting recording, ending recording, adjusting a transmission level, ending a present call, or performing a custom action.

As an implementation, the device for voice control in the present embodiment may further include a judgment module and a first processing module. The judgment module is configured to determine, after the first collection module 32 collects second voice information, whether third voice information is received within a preset time.

The first processing module is configured to control, when it is determined that the third voice information is received within the preset time, the first collection module 32 to stop collecting the second voice information. Correspondingly, the device for voice control further includes a second processing module, which is configured to instruct, when it is determined that the third voice information is not received within the preset time, the control module 34 to stop controlling the call process according to the second voice information.

It is to be noted that each of the above modules may be implemented by software or hardware. For the latter, it may be implemented by, but not limited to, the following manners. The above modules are all located in the same processor; or, the above modules are located in different processors in any combination respectively.

### Third Embodiment

The present embodiment is an optional embodiment according to the disclosure, which is used to describe the disclosure in detail in conjunction with a specific scene.

The present embodiment provides a method and a device for performing voice control during a call process. By detecting “open tag of a voice control command” and “terminator of a voice control command”, “voice control command of a call process” of a user during a communication process is acquired to automatically adjust a call volume, thereby a better and more convenient communication experience can be provided.

The present embodiment describes a method and a device for performing voice control during a call process. The device mainly includes a main control subsystem, a wireless signal transceiver subsystem, a memory subsystem, a voice signal transmitting subsystem, a voice signal receiving subsystem, a human-computer interaction interface subsystem, and a voice recognition control subsystem. The main control subsystem is configured to perform encoding process on each signal, various operation processing on a device, and unified management on the wireless signal transceiver subsystem, the memory subsystem, the voice signal transmitting subsystem, the voice signal receiving subsystem, the human-computer interaction interface subsystem, and the voice recognition control subsystem. The wireless signal transceiver subsystem is configured to transmit and receive a wireless radio frequency signal, so as to establish and maintain communication links. The memory subsystem is configured to store data such as software configuration and various function configuration parameters of a communication device. The voice signal transmitting subsystem is responsible for receiving a voice signal from a user. The voice signal receiving subsystem is configured to deliver a voice message of a communication partner to the user. The human-computer interaction interface subsystem completes operations of a user on the device, such as making a call and answering a call. The voice recognition control subsystem completes the voice print setting and recognizes a voice command issued by the user by the voice signal transmitting subsystem, and then feeds back a required response operation to the main control subsystem.

A method for automatically adjusting the call volume described in the present embodiment includes the following operations. A user voice is collected by a voice signal transmitting subsystem and a voice recognition control subsystem in advance to acquire voiceprint information of the user, and a user matching the voiceprint information is set as a main control user. “open tag of a voice control command”, “terminator of a voice control command” and “voice control command in a call process” during a call process are set as specific sentences. The “open tag of a voice control command”, the “terminator of a voice control command” and the “voice control command in a call process” may be multiple different specific sentences, but they must be different from each other independently. Response operations of the “voice control command in a call process” may be multiple preset function operations (such as adjusting a received volume, starting recording, and adjusting a transmission level), or may be a certain function operation customized by the user. The “voice control commands in a call process” of different response operations must also be different from each other independently. After the communication is successfully established, during the communication process, when the user issues “open tag of a voice control command”+“voice control command in a call process”+“terminator of a voice control command”, the voice recognition control subsystem detects the “open tag of a voice control command” and the “terminator of a voice control command” as well as the “voice control command in a call process” in the middle thereof, recognizes the “voice control command in a call process” of the main control user, and reports a required response operation to the main control subsystem. Then, the main control subsystem adjusts and controls each subsystem, and completes the response operation corresponding to the “voice control command in a call process”. Thus, a function of voice control operation during the call process is realized.

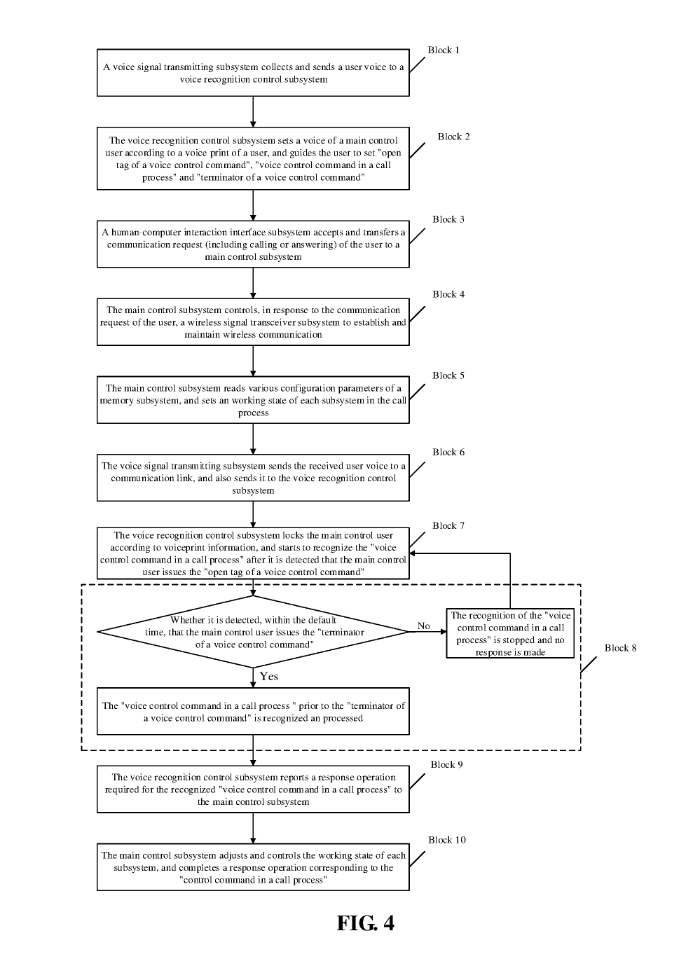

The present embodiment provides a method and device for performing voice control during a call process. FIG. 4 is a flow diagram of a method according to an embodiment of the disclosure. The method includes the operations as follows.

At block 1, a voice signal transmitting subsystem collects and sends a user voice to a voice recognition control subsystem.

At block 2, the voice recognition control subsystem sets a voice of a main control user according to a voice print of a user, and guides the user to set “open tag of a voice control command”, “voice control command in a call process” and “terminator of a voice control command”.

At block 3, a human-computer interaction interface subsystem accepts and transfers a communication request (including calling or answering) of the user to a main control subsystem.

At block 4, the main control subsystem controls, in response to the communication request of the user, a wireless signal transceiver subsystem to establish and maintain wireless communication.

At block 5, the main control subsystem reads various configuration parameters of a memory subsystem, and sets a working state of each subsystem in the call process.

At block 6, the voice signal transmitting subsystem sends the received user voice to a communication link, and also sends it to the voice recognition control subsystem.

At block 7, the voice recognition control subsystem locks the main control user according to voiceprint information, and starts to recognize the “voice control command in a call process” after it is detected that the main control user issues the “open tag of a voice control command”.

At block 8, when the voice recognition control subsystem detects, within the default time, that the main control user issues the “terminator of a voice control command”, the “voice control command in a call process” prior to the “terminator of a voice control command” is recognized and processed. When “terminator of a voice control command” issued by the main control user is not detected within the default time, the recognition of the “voice control command in a call process” is stopped and no response is made, and the “open tag of a voice control command” is continued to be detected.

At block 9, the voice recognition control subsystem reports a response operation required for the recognized “voice control command in a call process” to the main control subsystem.

At block 10, the main control subsystem adjusts and controls the working state of each subsystem, and completes a response operation corresponding to the “voice control command in a call process”.

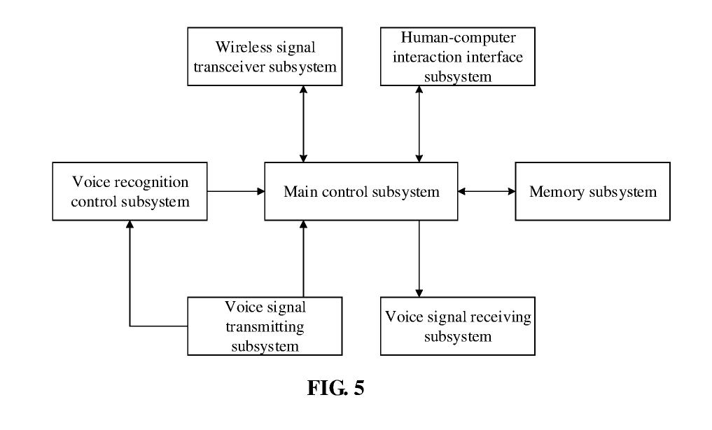

FIG. 5 illustrates an embodiment of a system interaction of a device according to an embodiment of the disclosure, including a main control subsystem, a wireless signal transceiver subsystem, a memory subsystem, a human-computer interaction interface subsystem, a voice signal transmitting subsystem, a voice signal receiving subsystem and a voice recognition control subsystem.

The main control subsystem is configured to perform encoding process on each signal, various operation processing on a device, and unified management on the wireless signal transceiver subsystem, the memory subsystem, the voice signal transmitting subsystem, the voice signal receiving subsystem, the human-computer interaction interface subsystem and other subsystems.

The wireless signal transceiver subsystem is configured to transmit and receive a wireless radio frequency signal, so as to establish and maintain communication links.

The memory subsystem is configured to store data such as software configuration and various parameters of a communication device.

The human-computer interaction interface subsystem receives a communication request of a user to a device for processing.

The voice signal transmitting subsystem is responsible for receiving a voice signal from a user.

The voice signal receiving subsystem is configured to deliver a voice signal of a communication partner.

The voice recognition control subsystem completes voice print setting and recognizes a voice command issued by the user via the voice signal transmitting subsystem, and then feeds back a required response operation to the main control subsystem.

The present embodiment is described in combination with an application scene in the following.

User A wants to perform voice communication with user B via a communication device. Before performing a communication behavior, the voice signal transmitting subsystem sends a user voice to the voice recognition control subsystem to complete the voice print setting, locks the user A as a main control user, and then sets the “open tag of a voice control command” to “wait a moment, voice control” according to guidance of the recognition control subsystem. The “voice control command in a call process” is set to “increase volume”, and its response operation is to increase a call volume. The “voice control command in a call process” is set to “decrease volume”, and its response operation is to decrease the call volume. The “terminator of a voice control command” is set to “execute”. When the communication is established and the call is started, the main control subsystem first reads audio output configuration parameters in the memory to set a volume level of the voice signal receiving subsystem. In the call process, the voice signal transmitting subsystem simultaneously sends a content of the user voice to the voice recognition control subsystem. When the user A feels that the received voice of the user B is too small to hear clearly, the user A says: “Wait a moment, voice control: increase volume, execute”. The voice recognition control subsystem determines that the user A is a main control user according to voiceprint information, starts to recognize the “voice control command in a call process” after the “open tag of voice control command” namely “wait a moment, voice control” is detected, and then stops recognizing the “voice control command in a call process” after the “terminator of a voice control command” namely “execute” is detected. In the process, the “voice control command in a call process” namely “increase volume” is recognized, and a required response operation which is increasing the call volume, corresponding to the voice command, is reported to the main control subsystem. The main control subsystem adjusts the audio output configuration parameters to increase the call volume of the voice signal receiving subsystem, so that a volume of the received voice signal of the user B is increased. In a quiet environment, the user A feels that the received voice of user B is loud, because it will affect others people or other reasons, the user A said: “Wait a moment, voice control: decrease volume, execute”. The voice recognition control subsystem determines that the user A is a main control user according to voiceprint information, starts to recognize the “voice control command in a call process” after the “open tag of a voice control command” namely “wait a moment, voice control” is detected, and then stops recognizing the “voice control command in a call process” after the “terminator of a voice control command” namely “execute” is detected. In the process, the “voice control command in a call process” namely “decrease volume” is recognized, and a required response operation which is decreasing the call volume, corresponding to the voice command, is reported to the main control subsystem. The main control subsystem adjusts the audio output configuration parameters to decrease the call volume of the voice signal receiving subsystem, so that a volume of the received voice signal of the user B is decreased.

In the present embodiment, by detecting and recognizing the voice control command of the user, the required response operation is reported to the main control subsystem, and then the main control subsystem adjusts the audio output configuration parameters, and the volume of the received voice is automatically adjusted, so that the communication effect is ensured while the use experience is optimized. The voice information of the user during the call process is detected and recognized, and a control operation that the user wants to perform is automatically completed according to the recognition result, which not only ensures the communication quality but also optimizes the user experience.

### Fourth Embodiment

The embodiment of the disclosure also provides a storage medium. Optionally, in the present embodiment, the above storage medium may be configured to store a program code for performing the operations as follows.

At S1, it is detected, during a call process, whether first voice information occurs.

At S2, second voice information is collected after the first voice information is acquired.

At S3, the call process is controlled according to the second voice information.

As an implementation, in the present embodiment, the above storage medium may include, but is not limited to, various media capable of storing a program code such as a U disk, a read-only memory (ROM), a random access memory (RAM), a mobile hard disk, a magnetic disk or an optical disc.

As an implementation, in the present embodiment, the processor may be configured to execute the following operation according to the program code stored in the storage medium. It is detected, during a call process, whether first voice information occurs.

As an implementation, in the present embodiment, the processor may be configured to execute the following operation according to the program code stored in the storage medium. Second voice information is collected after the first voice information is acquired.

As an implementation, in the present embodiment, the processor may be configured to execute the following operation according to the program code stored in the storage medium. The call process is controlled according to the second voice information.

As an implementation, a specific example in the present embodiment may refer to the examples described in the above embodiments and alternative implementations, and details are not described herein in the present embodiment.

In several embodiments according to the present disclosure, it is to be understood that the disclosed device and method may be implemented in other manners. The device embodiments described above are merely illustrative. For example, the division of the units is only a division of logical functions. In actual implementation, there may be another division manner For example, multiple units or components may be combined or integrated into another system, or some features may be ignored or not executed. In addition, coupling, direct coupling or communication connection displayed or discussed between various components may be indirect coupling or communication connection via some interfaces, devices or units, and may be in an electrical, mechanical or other form.

The above units described as separate components may or may not be physically separated. The components displayed as units may or may not be physical units, that is, they may be arranged in one place, or may be distributed to multiple network units. Some or all of the units may be selected according to actual needs to achieve the purpose of the solution of the present embodiment.

In addition, functional units in embodiments of the disclosure may be integrated into one processing unit, or each unit may exist physically separately, or two or more units may be integrated into one unit. The above integrated unit may be implemented in the form of hardware or in the form of hardware and software functional units.

Those skilled in the art can understand that all or part of the operations of implementing the above method embodiments may be completed by using hardware related to program instructions, and the foregoing program may be stored in a computer readable storage medium. The program is executed to perform the operations in the above method embodiments. The foregoing storage medium includes various media capable of storing program codes such as a mobile storage device, a ROM, a RAM, a magnetic disk, or an optical disc.

Or, the above integrated units in the disclosure may be stored in a computer readable storage medium when being implemented in the form of a software functional module and sold or used as a standalone product. Based on such understanding, a part of the technical solution in the embodiments of the disclosure, which is essential or makes a contribution to the related art, may be embodied in the form of a software product. The computer software product is stored in a storage medium, including several instructions used to cause a computer device (which may be a personal computer, a server, or a network device, etc.) to perform all or part of the methods according to the embodiments of the disclosure. The foregoing storage medium includes various media capable of storing program codes, such as a mobile storage device, a ROM, a RAM, a magnetic disk, or an optical disc.

The above is only the specific implementation of the disclosure, but the scope of protection of the disclosure is not limited thereto. All the variations or alternatives that readily occur to any of those skilled in the art within the technical scope disclosed in the disclosure, should be covered by the scope of protection of the disclosure. Therefore, the scope of protection of the disclosure should be subject to the scope of the claims.

### INDUSTRIAL APPLICABILITY

In the technical solutions of the embodiments of the disclosure, it is detected, during a call process, whether first voice information occurs. Second voice information is collected after the first voice information is acquired. The call process is controlled according to the second voice information. The technical problem in the related art that voice control cannot be performed during a call process can be solved, thereby providing a better and more convenient communication experience.

1. A method for voice control, comprising:
detecting, during a call process, whether first voice information occurs;
collecting second voice information after the first voice information is acquired; and
controlling the call process according to the second voice information.

2. The method according to claim 1, further comprising: before detecting whether first voice information occurs,
collecting voiceprint information of a call user; and
determining whether the voiceprint information of the call user matches prestored voiceprint information.

3. The method according to claim 1, wherein at least one of the following controls is performed on the call process according to the second voice information: adjusting a received volume, starting recording, ending recording, adjusting a transmission level, ending a present call, or performing a custom action.

4. The method according to claim 1, further comprising: after second voice information is collected,
determining whether third voice information is received within a preset time; and
stopping collecting the second voice information when it is determined that the third voice information is received within the preset time.

5. The method according to claim 4, wherein when it is determined that the third voice information is not received within the preset time, the method further comprises:
instructing to stop controlling the call process according to the second voice information.

6. A device for voice control, comprising:
a processor; and
a memory storing instructions, which, when executed by the processor, cause the processor to execute operations comprising:
detecting, during a call process, whether first voice information occurs;
collecting second voice information after acquiring the first voice information; and
controlling the call process according to the collected second voice information.

7. The device according to claim 6, wherein the processor is further configured to execute operations comprising:
collecting voiceprint information of a call user before detecting whether the first voice information occurs; and
determining whether the voiceprint information of the call user matches prestored voiceprint information.

8. The device according to claim 6, wherein the processor is further configured to execute an operation comprising:
performing, according to the second voice information, at least one of the following controls on the call process: adjusting a received volume, starting recording, ending recording, adjusting a transmission level, ending a present call, or performing a custom action.

9. The device according to claim 6, wherein the processor is further configured to execute operations comprising:
determining whether third voice information is received within a preset time after collecting second voice information; and
controlling, when it is determined that the third voice information is received within the preset time, to stop collecting the second voice information.

10. The device according to claim 9, wherein the processor is further configured to execute an operation comprising:
instructing, when it is determined that the third voice information is not received within the preset time, to stop controlling, the call process according to the second voice information.

11. A non-transitory computer storage medium having stored thereon computer-executable instructions to execute a method for voice control, wherein the method comprises:
detecting, during a call process, whether first voice information occurs;
collecting second voice information after the first voice information is acquired; and
controlling the call process according to the second voice information.

12. The non-transitory computer storage medium according to claim 11, wherein the computer-executable instructions are further configured to execute operations comprising:
collecting voiceprint information of a call user; and
determining whether the voiceprint information of the call user matches prestored voiceprint information.

13. The non-transitory computer storage medium according to claim 11, wherein the computer-executable instructions are further configured to execute an operation comprising:
performing at least one of the following controls on the call process according to the second voice information: adjusting a received volume, starting recording, ending recording, adjusting a transmission level, ending a present call, or performing a custom action.

14. The non-transitory computer storage medium according to claim 11, wherein the computer-executable instructions are further configured to execute operations comprising:
determining whether third voice information is received within a preset time; and
stopping collecting the second voice information when it is determined that the third voice information is received within the preset time.

15. The non-transitory computer storage medium according to claim 14, wherein the computer-executable instructions are further configured to execute an operation comprising:
instructing to stop controlling the call process according to the second voice information.

16. The method according to claim 1, wherein the method is performed by a terminal capable of performing human-computer interaction by voice.

17. The method according to claim 4, wherein the first voice information, the second voice information and the third voice information are set specific sentences.

18. The device according to claim 9, wherein the first voice information, the second voice information and the third voice information are set specific sentences.

19. The non-transitory computer storage medium according to claim 14, wherein the first voice information, the second voice information and the third voice information are set specific sentences.
